(19) United States
(12) Patent Application Publication
(10) Pub. No.: US 2003/0228204 A1
(43) Pub. Date: Dec. 11, 2003

(54) Connector plate

(76) Inventors: Philip Bear, Burnsville, MN (US); Brian W. Jacobs, Maple Grove, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/434,260

(22) Filed: May 8, 2003

Related U.S. Application Data
(60) Provisional application No. 60/387,786, filed on Jun. 11, 2002.

(51) Int. Cl. F16B 15/00

(52) U.S. Cl. 411/466

(57) ABSTRACT

A connector plate including a base plate, at least one central attachment mechanism, and at least one corner attachment mechanism. The base plate is defined by two opposing sides and two opposing ends that extend between the opposing sides. The at least one central attachment mechanism is formed on the base plate. The at least one corner attachment mechanism is formed on the base plate proximate intersection of one of the opposing sides and one of the opposing ends.

### PRIORITY CLAIM

The present application claims priority to provisional patent application serial No. 60/387,786 filed on Jun. 11, 2002. The referenced provisional patent application is hereby incorporated by reference.

### FIELD OF THE INVENTION

The invention relates generally to connector plates. More particularly, the present invention relates to an improved connecting plate that reinforces and/or joins one or more pieces of wood.

### BACKROUND OF THE INVENTION

Connector plates are generally utilized for joining and interconnecting wooden members that form the structural trusses in residential housing. Additionally, connector plates are employed in wooden pallet construction. Connector plates typically include a base plate and an array of sharp projection impaling members that extend outward from the base plate. Pressing or pounding the base member of the connector plate can permanently join adjacent wooden members with coplanar surfaces so that the impaling members penetrate the wooden members.

Connector plates are typically manufactured by striking out the projections from a steel sheet stamp. The stamp is generally oriented perpendicular to the sheet. As the stamp pierces the sheet apertures are created along with the projections extending outward from the base. These projections act as impaling members creating a tight bond with the wooden members.

The prior art of connector plates is quite extensive. A considerable amount of the prior art focuses on the tooth-like projections and the methods employed for manufacturing them. The following patents claim pairs of tooth-like projections with various shapes and forms: U.S. Pat. No. 4,418,509 to Moyer et al.; U.S. Pat. No. 4,343,580 to Moyer et al.; U.S. Pat. Nos. 3,603,197 to Wood; 3,633,454 to Schmitt et al.; U.S. Pat. No. 3,951,033 to Moelenpah; U.S. Pat. No. 4,165,672 to Jureit et al.; U.S. Pat. No. 3,703,304 to Losee; U.S. Pat. No. 5,848,866 to Black, Jr.; and U.S. Pat. No. 4,318,652 to Gore.

U.S. Pat. No. 6,299,378 to Griffith discloses a connector plate with “teeth” of increased length in various regions of the connector plate. Further, the following patents teach various forms of connector plates, which employ “tooth-like” projections: U.S. Pat. No. 4,570,407 to Palacio et al.; U.S. Pat. No. 6,412,246 to Tadich; U.S. Pat. No. 3,503,173 to Jureit; U.S. Pat. No. D286,855 to Paul; U.S. Pat. No. D287,223 to Paul; and U.S. Pat. No. 4,464,885 to Palacio et al. U.S. Pat. No. 5,234,279 to Poutanen teaches a connector plate with “edge prongs.”

The inventive aspects of the present invention are not taught nor disclosed within the prior art. A problem associated with the prior art is that there is a tendency for the connector plates to become disengaged completely or partially from the wooden members. Disengagement occurs from torsional forces exerted upon the wooden members themselves, or sheer forces exerted upon the edges of the connector plates. This process often exposes the edges of the connector plates to further disengagement and creates a safety hazard. Disengagement of the connector plates decreases the structural integrity of the joint or the wooden pallet member. Furthermore, exposed edges may cut and tear construction elements or injure persons coming in close contact therewith. Even partial disengagement is to be avoided, as this can lead to complete disengagement.

The present invention accomplishes a solution to this potential problem. An inventive and novel design not taught or disclosed in the prior art is the subject of the corner design for the present invention.

### BRIEF DESCRIPTION OF THE DRAWINGS

FIG. 1 is an upper perspective view of a nine-aperture connector plate attached to a wooden member.

FIG. 2 is a lower perspective view of a twelve-aperture connector plate.

### SUMMARY OF THE INVENTION

A connector plate having a base plate, at least one central attachment mechanism, and at least one corner attachment mechanism. The base plate is defined by two opposing sides and two opposing ends that extend between the opposing sides. The at least one central attachment mechanism is formed on the base plate. The at least one corner attachment mechanism is formed on the base plate proximate intersection of one of the opposing sides and one of the opposing ends.

The purpose and benefit of the corner design of the present invention is two-fold: to add strength by providing additional teeth which are forced into the wood, and to secure the corners down tight to the wood surface, thus preventing dangerous raised corners. The latter is a particular problem since, in practice, the corners of the plates are often above the surface of the wood to a slight degree, creating a significant safety hazard from the raised corner. In some cases, the use of mending, or reinforcing plates, is specifically prohibited due to the safety concerns caused by raised corners. The use of the Porcupine corner ensures the corner is held tight to the wood and serves to bury the otherwise hazardous corner in the wood material.

### DETAILED DESCRIPTION OF THE INVENTION

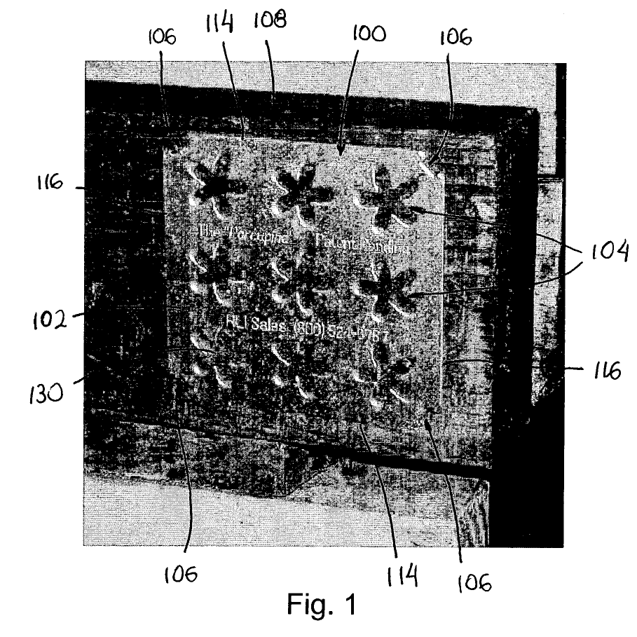

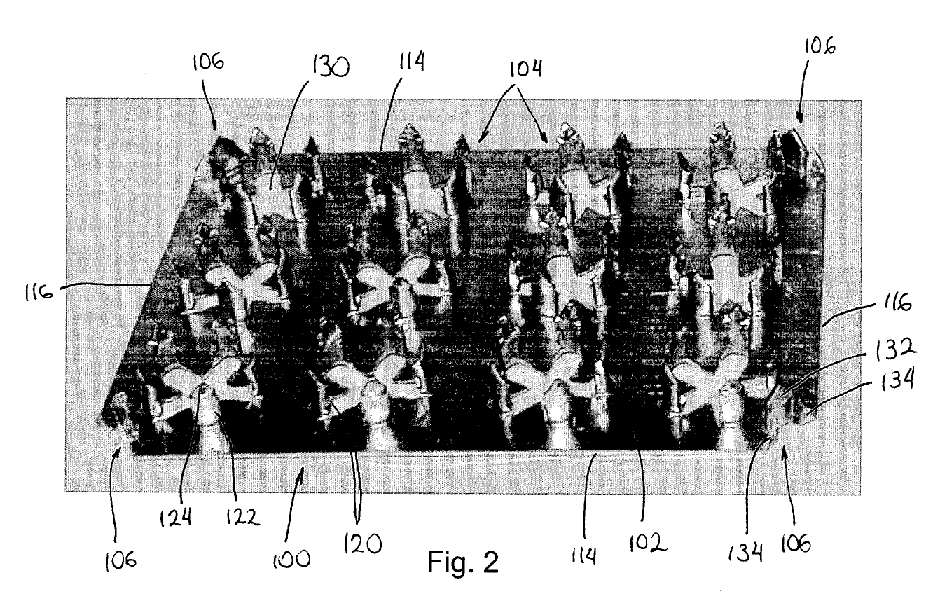

Referring to FIGS. 1-2, a connector plate of the present invention is generally designated in the drawings by the reference numeral 100. The connector plate 100 contains a base plate 102 that includes at least one central attachment mechanism 104 and at least one corner attachment mechanism 106.

The connector plate 100 is attached to a wood member 108 to strengthen the wood member 108 or to attach together wood members 108 such as in a truss. While the concepts of the present invention are described with respect to wood, a person or ordinary skill in the art will appreciate that the concepts can be used in reinforcing or joining other types of materials.

The base plate 102 preferably has a substantially square or rectangular configuration and is defined by opposing sides 114 and opposing ends 116. The base plate 102 is preferably fabricated from a substantially flat metallic sheet. A person of ordinary skill in the art will appreciate that it is possible to form the base plate 102 in other shapes and from other materials using the concepts of the present invention.

The at least one central attachment mechanism 104 preferably includes a plurality of central attachment mechanisms 104 that are arranged in an array on the base plate 102. Each of the central attachment mechanisms 104 includes a plurality of projections 120 that extend substantially perpendicular from the base plate 102, as most clearly illustrated in FIG. 2. Preferably the central attachment mechanisms 104 each include five projections 120. However, a person of ordinary skill in the art will appreciate that the concepts of the present invention can be adapted for use with alternate numbers of projections 120.

The projections 120 each include a main portion 122 and a tip portion 124, which is attached to the main portion 122 distal the base plate 102. The main portion 122 preferably has a curved shape to provide the projections 120 with sufficient rigidity to resist bending during insertion. The tip portion 122 is preferably tapered to facilitate insertion of the connector plate 100 into the wood member 108 to which the connector plate 100 is attached.

The central attachment mechanisms 104 are preferably formed by stamping the base plate 102 to cause the projections 120 to be bent away from the base plate 102. The preferred pattern of the projections 120 enables the projections 120 to be formed with a minimal amount of waste material being generated. The central attachment mechanisms 104 thereby have a star-shaped aperture 130.

The structure of the central attachment mechanisms 104 enables the base plate 102 to retain a significant degree of rigidity to resist deformation when being attached to the board as well as resisting deformation when the combined connector plate 100 and board assembly are used after manufacture.

The corner attachment mechanisms 106 are preferably positioned at each of the corners of the base plate 102. Each of the corner attachment mechanisms 106 preferably includes a center projection 132 and a pair of side projections 134, which are located on either side of the center projection 132.

The corner attachment mechanisms 106 are preferably formed by stamping the base plate 102 to cause the center projection 132 and the pair of side projections 134 to be bent away from the base plate 102. The preferred pattern of the center and side projections 132, 134 enables the center and side projections 132, 134 to be formed with a minimal amount of waste material being generated.

As pressure is applied to the base plate 102 in a direction towards the wood member 108, the tip portions 124 begin to impale the wood member 108. Additionally, the center corner projections 132 and the side projections 134 impale the wood member 108 as pressure is applied.

After sufficient pressure has been applied to the base plate 102, the base plate 102 becomes substantially flush with the wood member 108 so that the central attachment mechanisms 104 and the corner attachment mechanism 106 are impended in the wood member 108, which in turn increases the structural integrity of the wood member 108 and decreases the likelihood of partial or total disengagement of the connector plate 100.

The connector plates 100 are preferably manufactured using a stamp to pierce the base plate 102, thereby producing the at least one central attachment mechanism 104 and the at least one corner attachment mechanism 106.

When two wood members 108 are joined together, the connecting plate 100 of the present invention enables the wooden members 108 to be permanently joined to increase the structural integrity of the joint. This process also produces an increase in stability.

The present invention may be used on a variety of steel plates and other materials for use in structural wood framing systems and wood pallet repair and construction industries where sections of lumber are joined or reinforced using a stamped steel plate that has been pressed into the wood on one or more sides.

Applications for plates such as these include, but are not limited to, roof trusses, floor joists, arches, new and repaired wood pallets, shipping container fabrication and others where wood members need to be either joined, strengthened or repaired.

The particular design of the corner can vary from single to multiple points, of which any configuration is to be covered by this patent application. The fabrication of the corner is completed during the stamping operation when the plate is manufactured. The corner projection(s) is (are) formed when the material is punched and forms a projection that runs perpendicular to the plane of the material. In certain cases, the corner projection is generated without removal of any steel, only shearing and brake forming.

In other cases, such as the single corner projection, material is cut from the sheet metal stock and the individual projection is brake formed into a perpendicular orientation. It is also a potential design that a single triangular corner projection can be formed by a simple bend in the corner, creating a full 90-degree angle corner projection. All such configurations are to be protected by the present patent application whether or not material is notched from the sides.

It is contemplated that features disclosed in this application, as well as those described in the above applications incorporated by reference, can be mixed and matched to suit particular circumstances. Various other modifications and changes will be apparent to those of ordinary skill.

1. A connector plate comprising:
a base plate defined by two opposing sides and two opposing ends, which extend between the opposing sides;
at least one central attachment mechanism formed on the base plate, wherein each of the central attachment mechanisms comprise a plurality of central projections positioned in a spaced-apart orientation around an aperture; and
at least one corner attachment mechanism formed on the base plate proximate intersection of one of the opposing sides and one of the opposing ends.

2. The connector plate of claim 1, wherein each of the central projections includes a main portion and a tip portion, wherein the main portion extends from the base plate and wherein the top portion is attached to the main portion opposite the base plate.

3. The connector plate of claim 1, wherein each of the central projections has a concave surface.

4. The connector plate of claim 1, wherein the aperture includes a central region and a plurality of side regions that extend from the central region, and wherein the central projections extend from the base plate proximate an end of each side region that is opposite the central region.

5. The connector plate of claim 1, wherein the plurality of central projections comprises at least four projections.

6. The connector plate of claim 1, wherein each of the corner attachment mechanisms comprise a center projection and a pair of side projections located on either side of the center projection.

7. The connector plate of claim 5, wherein the center projection is offset from the side projections.

8. A connector plate comprising:
a base plate; and
a plurality of central attachment mechanisms, wherein each of the central attachment mechanisms comprise a plurality of central projections positioned in a spaced-apart orientation around an aperture.

9. The connector plate of claim 8, wherein each of the central projections includes a main portion and a tip portion, wherein the main portion extends from the base plate and wherein the top portion is attached to the main portion opposite the base plate.

10. The connector plate of claim 8, wherein each of the central projections has a concave surface.

11. The connector plate of claim 8, wherein the aperture includes a central region and a plurality of side regions that extend from the central region, and wherein the central projections extend from the base plate proximate an end of each side region that is opposite the central region.

12. The connector plate of claim 8, wherein the plurality of projections comprises at least four projections.

13. The connector plate of claim 8, wherein the plurality of projections comprises five projections.

14. The connector plate of claim 8, wherein the base plate is defined by two opposing sides and two opposing end, which extend between the opposing side, wherein the connector plate further comprises a plurality of corner attachment mechanisms, wherein one of the corner attachment mechanisms is proximate an intersection of one of the opposing sides and one of the opposing ends, and wherein each of the corner attachment mechanisms comprise a center projection and a pair of side projections located on either side of the center projection.

15. A connector plate comprising:
a base plate defined by two opposing sides and two opposing ends, which extend between the opposing sides; and
a plurality of corner attachment mechanisms, wherein one of the corner attachment mechanisms is proximate an intersection of one of the opposing sides and one of the opposing ends, wherein each of the corner attachment mechanisms comprise a center projection and a pair of side projections located on either side of the center projection.

16. The connector plate of claim 15, and further comprising a plurality of central attachment mechanisms, wherein each of the central attachment mechanisms comprise a plurality of projections positioned in a spaced-apart orientation around an aperture.

17. The connector plate of claim 15, wherein the center projection is offset from the side projections.

18. The connector plate of claim 15, and further comprising a plurality of central attachment mechanisms, wherein each of the central attachment mechanisms comprise a plurality of projections positioned in a spaced-apart orientation around an aperture.

19. The connector plate of claim 18, wherein the aperture includes a central region and a plurality of side regions that extend from the central region, and wherein the central projections extend from the base plate proximate the end of each side region that is opposite the central region.
